(19) United States
(12) Patent Application Publication
(10) Pub. No.: US 2016/0143435 A1
(43) Pub. Date: May 26, 2016

(54) TRAVEL BOOKSTAND

(71) Applicant: WINVERTS, INC., Tustin, CA (US)

(72) Inventor: Seung Jin Kim, Irvine, CA (US)

(21) Appl. No.: 14/947,639

(22) Filed: Nov. 20, 2015

Related U.S. Application Data
(60) Provisional application No. 62/085,180, filed on Nov. 26, 2014.

(51) Int. Cl. A47B 23/04; B60N 3/00

(52) U.S. Cl. CPC A47B 23/044; B60N 3/004

(57) ABSTRACT

A stand for use in connection with a seatback tray of a passenger seat is disclosed. For example, the stand may include an anchoring member having: a top portion in a proximal plane, the top portion extending from a proximal top edge to a proximal bottom edge; a bottom portion in a distal plane, the bottom portion extending from a distal top edge to a distal bottom edge; a middle portion in a transverse plane intersecting the proximal and distal planes, the middle portion connected to the proximal bottom edge and the distal top edge, thereby connecting the top and bottom portions; and an opening formed in the anchoring member and sized to expose a tray lock of the tray therethrough. The apparatus may further include a cantilevered member interfacing with and rotatable with respect to the anchoring member via at least one hinge.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present application relates generally to portable stands, and more particularly to stands for supporting reading materials or portable electronic devices during travel.

### BACKGROUND

Travelers often carry reading items (e.g., magazines, books, etc.) or portable electronic devices (e.g., tablets, electronic books, etc.) onto planes, trains, buses, or the like. Some travelers use their hands to hold their reading items or portable electronic items. Some travelers place such items on a seatback tray when available. These approaches to holding or supporting such items can cause discomfort to the traveler, particularly during extended trips or commutes.

Various products exist for supporting or propping up reading/electronic items. Such products are typically designed to be placed on flat table or tray surface. Depending on the height of the traveler, reading from an item on placed/propped on top of a seatback tray (which has been released from the upright position and lowered), may cause neck and/or eye strain. In addition, a bookstand that is simply placed on top of the seatback tray is typically not securely attached to the tray, and may move or shift during the flight. The bookstand may be knocked over by the travelers/passengers or due to turbulence experienced the flight or commute. In this context, there remains a need for an apparatus that holds a reading/electronic item at a level comfortable to the traveler/reader (e.g., at or near eye level), and is securely anchored during travel.

### SUMMARY

The devices and methods of this disclosure each have several innovative aspects, no single one of which is solely responsible for the desirable attributes disclosed herein. One aspect of this disclosure provides an apparatus and method for supporting a reading/electronic item. The apparatus may be used in connection with a seatback tray of a passenger seat that is hingedly connected to the passenger seat and configured to be secured in an upright position by locking with a tray lock of the passenger seat. The apparatus may include an anchoring member having a top portion, a middle portion, and a bottom portion in a single piece body; the top portion in a proximal plane, the top portion extending from a proximal top edge to a proximal bottom edge; the bottom portion in a distal plane, the bottom portion extending from a distal top edge to a distal bottom edge; and the middle portion in a transverse plane intersecting the proximal and distal planes, the middle portion connected to the proximal bottom edge and the distal top edge, thereby connecting the top and bottom portions. The apparatus may include an opening formed in the single piece body of the anchoring member and sized to expose the tray lock for locking and unlocking therethrough. The apparatus may further include at least one hinge at the proximal top edge of the anchoring member. The apparatus may further include a cantilevered member interfacing with and rotatable with respect to the anchoring member via the at least one hinge, the cantilevered member having an object support member. In related aspects, a method of using the above-described apparatus is also provided.

### BRIEF DESCRIPTION OF THE DRAWINGS

FIG. 1A shows an exemplary stand with a cantilevered member turned upward.

FIG. 1B shows the stand of FIG. 1A with the cantilevered member turned downward.

FIGS. 2A-2C show an exemplary stand placed between a seat and a seatback tray.

FIG. 3 shows the anchored member and the cantilevered member of a stand separated from each other.

FIGS. 4A-4C show other embodiments of a stand.

FIGS. 5A-5C illustrate use of a stand in accordance with aspects of the present disclosure.

FIGS. 6A-6C provide a perspective view of FIGS. 5A-5C, respectively.

FIGS. 7A-7B show yet another embodiment of a stand.

FIG. 8 provides an exploded view of the stand of FIGS. 7A-7B.

FIGS. 9A-9B show still another embodiment of a stand.

FIG. 10 provides an exploded view of the stand of FIGS. 9A-9B.

FIG. 11 shows another embodiment of a stand.

FIG. 12 shows yet another embodiment of a stand.

### DETAILED DESCRIPTION

The detailed description set forth below in connection with the appended drawings is intended as a description of exemplary embodiments of the disclosure and is not intended to represent the only embodiments in which the features of the disclosure may be practiced. Like reference numerals in the drawings refer to like elements throughout. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments.

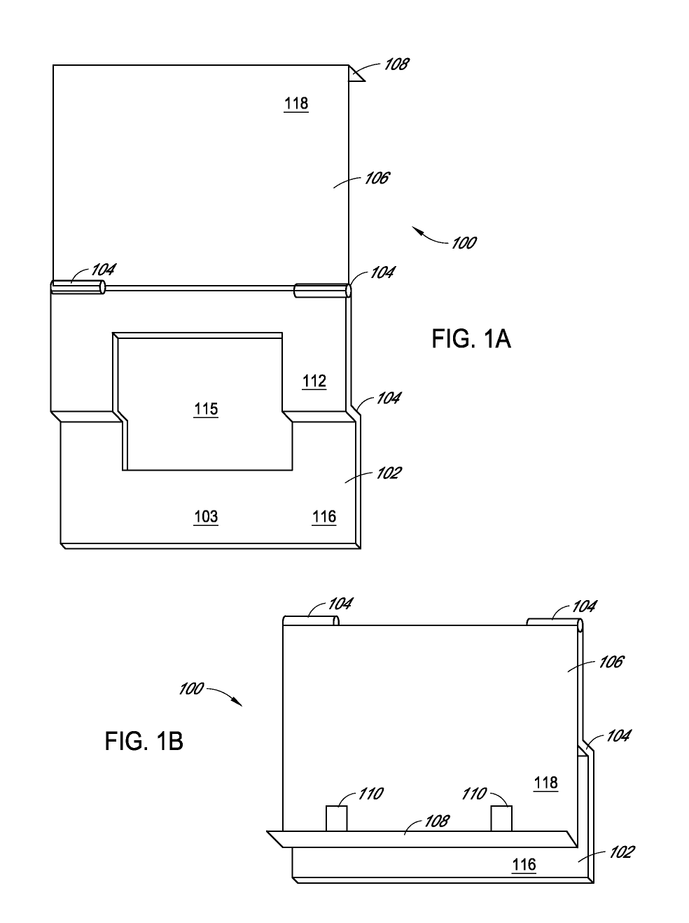

With reference to FIGS. 1A-B, there is provided an exemplary embodiment of a stand 100 when assembled. The stand 100 may include an anchoring member 102 and a cantilevered member 106 that are connected and interface with each other via one or more hinge(s) 104.

The anchoring member 102 may include a top portion 112 in a proximal plane, the top portion 112 extending from a proximal top edge to a proximal bottom edge. The anchoring member 102 may include a bottom portion 116 in a distal plane, the bottom portion 116 extending from a distal top edge to a distal bottom edge. The anchoring member 102 may include a middle portion 114 in a transverse plane intersecting the proximal and distal planes, the middle portion 114 connected to the proximal bottom edge and the distal top edge, thereby connecting the top and bottom portions 112, 116.

The hinges 104 may be located at the proximal top edge of the anchoring member 102. The cantilevered member 106 may interface with and be rotatable with respect to the anchoring member 102 via the hinges 104. The cantilevered member 106 may include one or more object support member(s) 108. The object support member 108 may optionally include one or more retainers/clips 110 for retaining or securing a reading/electronic item in place to prevent the reading/electronic item from falling or shifting.

FIG. 1A depicts the stand 100 when the cantilevered member 106 is turned upward, at an angle of about 180 degrees relative to the anchoring member 102. FIG. 1B depicts the stand 100 when the cantilevered member 106 is turned downward, at an angle of about 0 degrees relative to the anchoring member 102. It is noted that the cantilevered member 106 and/or the anchoring member 102 may be rotated about the hinges 104, and that the members 102, 106 may be adjustably positioned relative to each other. It is further noted that the members 102, 106 may be adjustably positioned to form an angle in between about 0 to about 180 degrees relative to each other, such as, for example, at about 15 degrees, at about 25 degrees, etc.

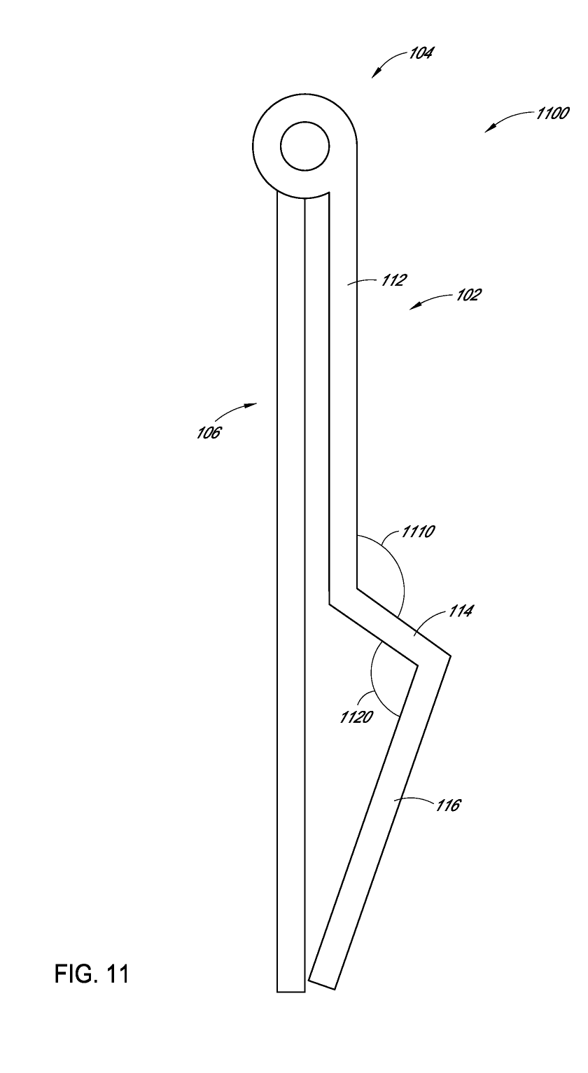

In related aspects, the proximal plane (in which the top portion 112 of the anchoring member 102 lies) and the transverse plane (in which the middle portion 114 of the anchoring member 102 lies) may intersect to form an angle (e.g., an angle 1110 of FIG. 11) that is less than about 150 degrees relative to each other. In one example, the proximal and transverse planes of the anchoring member 102 may intersect to an angle of about 80, about 85, about 90, about 95, about 100, about 105, about 110, about 115 or about 120 degrees. In another example, the angle (e.g., the angle 1110 of FIG. 11) formed by the intersection of the proximal and transverse planes may be in a range between (inclusive or exclusive of) two of the angles listed in the example of the previous sentence.

In further related aspects, the distal plane (in which the bottom portion 116 of the anchoring member 102 lies) and transverse plane (in which the middle portion 114 of the anchoring member 102 lies) may intersect to form an angle (e.g., an angle 1120 of FIG. 11) that is less than about 120 degrees relative to each other. In one example, the distal and transverse planes of the anchoring member 102 may intersect to form an angle of about 75, about 80, about 85, about 90, about 95, about 100, or about 105 degrees. In another example, the angle (e.g., the angle 1120 of FIG. 11) formed by the intersection of the distal and transverse planes of the anchoring member 102 may be in a range between (inclusive or exclusive of) two of the angles listed in the example of the previous sentence.

In yet further related aspects, the portions 112, 114, 116 of the anchoring member 102 together may form or be a single piece body or an external member of the anchoring member 102 that surrounds and defines an inner opening 115 within the anchoring member 102. The opening 115 may provide for a stand 100 that is lightweight and easy for the traveler to carry or transport. The opening 115 within the anchoring member 102 is sized to expose a tray lock in a seatback, which may be used to secure the stand 100, as explained in further detail below.

In still further related aspects, the anchoring member 102 may include or be an anchoring panel (e.g., that includes the portions 112, 114, 116), and the cantilevered member 106 may include or be a cantilevered panel 118.

In related aspects, exemplary dimensions of the stand 100 are as follows. In one example, the cantilevered member 106 may have a height of about 6 inches and a width of about 9 inches. The anchoring member 102 may have similar dimensions, i.e., a height of about 6 inches and a width of about 9 inches. The external member of the anchoring member 102 may have a lateral thickness of about 1.5 inches, and the opening 115 may have a width of about 6 inches and a height of about 3 inches.

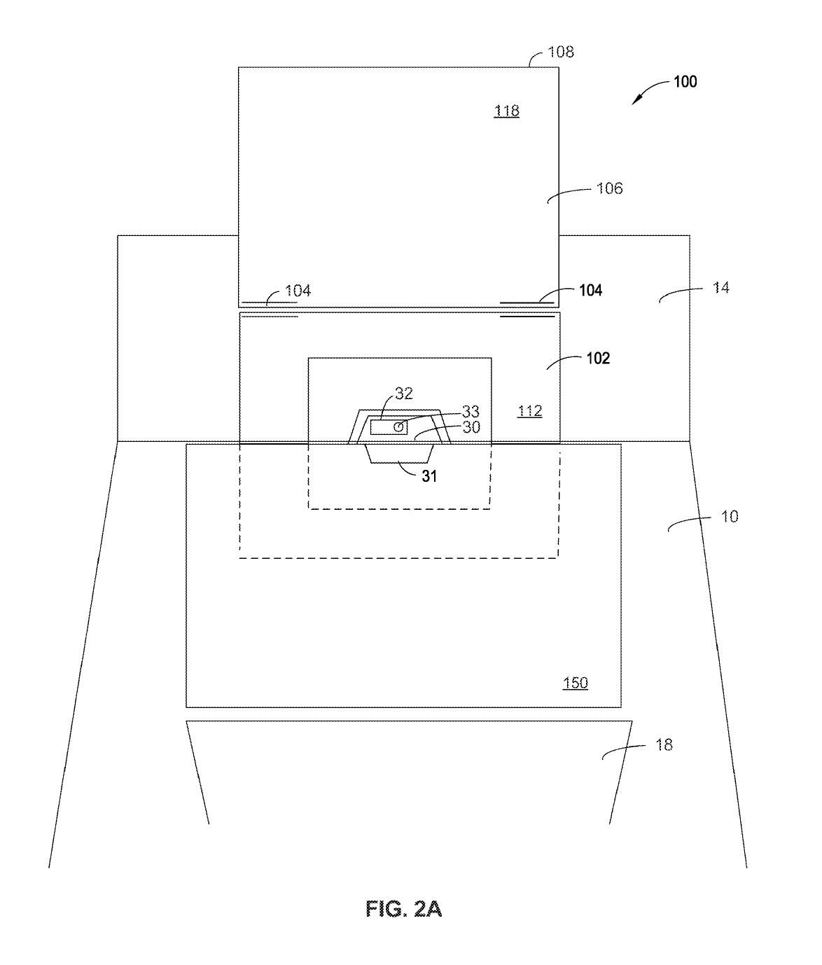

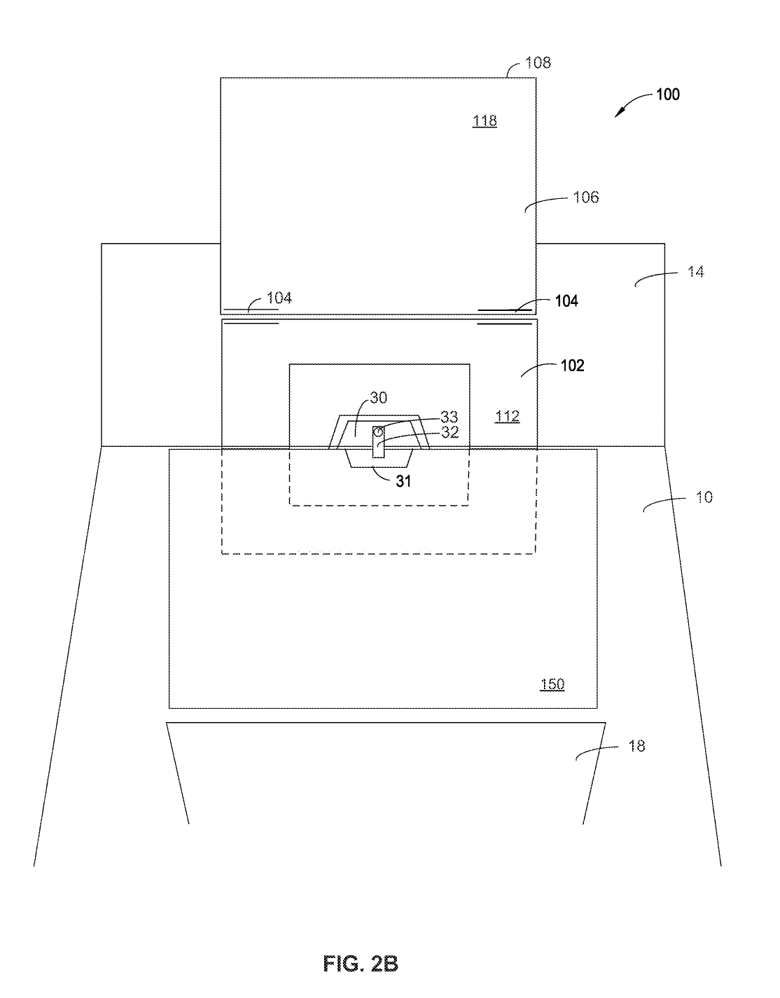

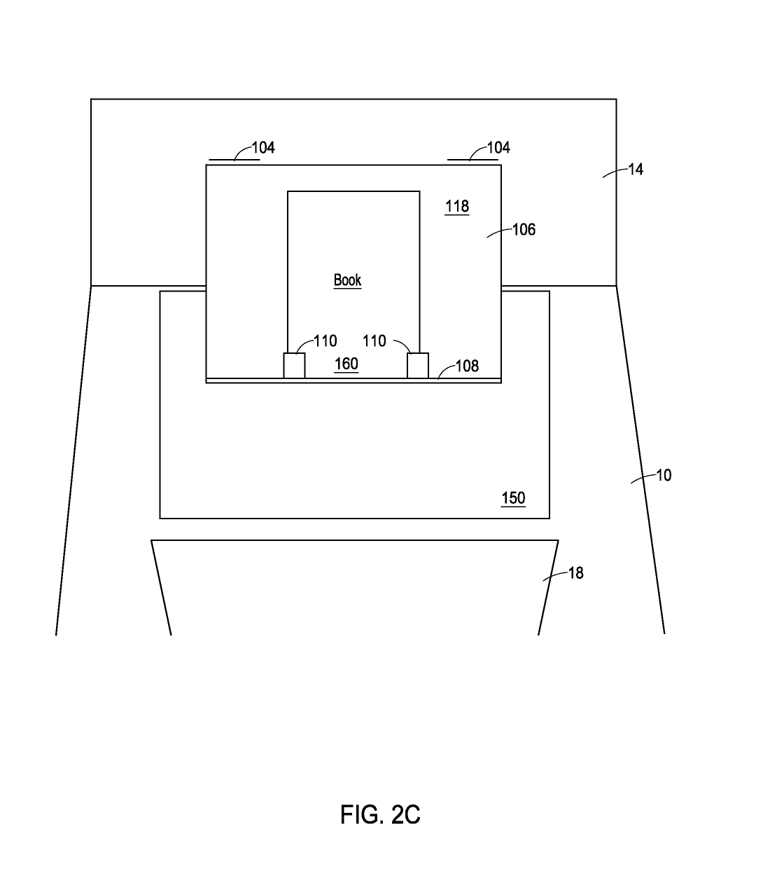

FIGS. 2A-C show placement of the stand 100 between a seatback tray 150 and a passenger seat 10 in front of a user of the stand 100. From the user's vantage point from behind the seat 10, the user may see the back of a headrest 14, the seatback tray 150 (depicted in an upright position) below the headrest 14, and a seatback pocket 18 below the seatback tray 150.

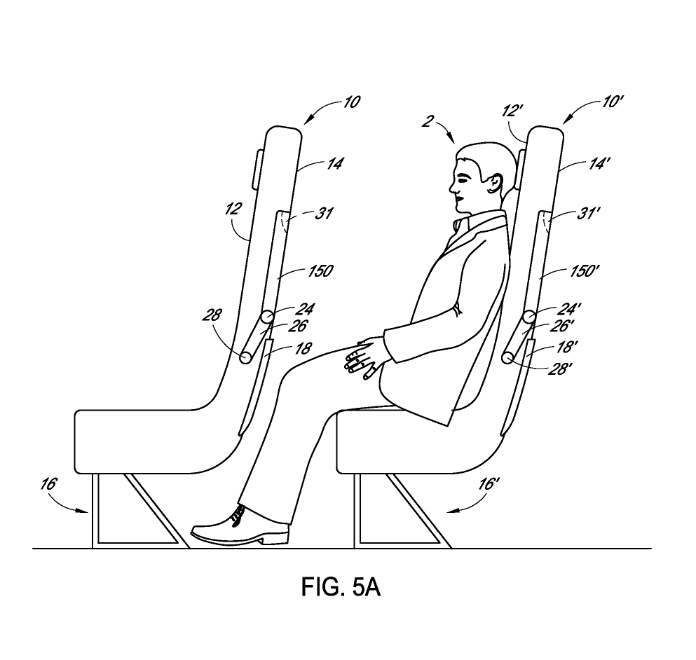

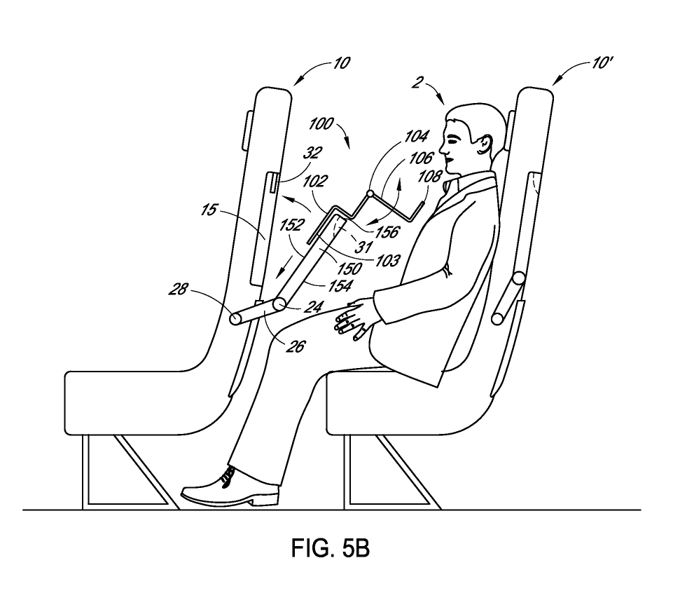

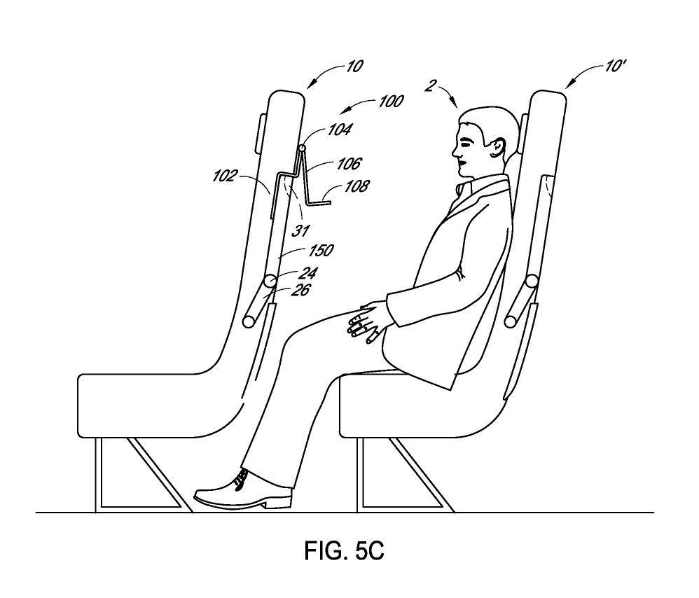

With reference to FIG. 2A, the stand 100 is shown with its cantilevered member 106 turned upward, at an angle of about 180 degrees relative to its anchoring member 102. The anchoring member 102 of the stand 100 may be placed between the tray 150 and the seat 10. In one example, the bottom portion 116 of the anchoring member 102 may be placed between a tray top surface (e.g., tray top surface 152 in FIG. 5B) of the tray 150 and a receiving portion (not shown) of the seat 10, wherein the receiving portion receives the tray 150 when the tray 150 is placed or secured in an upright position. The bottom portion 116 may include a bottom portion top surface (not shown) that may be aligned with the tray top surface, such that the bottom portion top surface and the tray top surface are flush with each other.

The back of the seat 10 may include a groove/indentation 30 above a groove/indentation 31 of the tray 150. The seat 10 may also include a locking member 32 that may be rotated about an axis 33. The locking member 32 is shown in an up or unlocked position (i.e., the locking member 32 is turned upward into the groove 30) in FIG. 2A.

FIG. 2B shows the locking member 32 in a down or locked position (i.e., the locking member 32 is turned downward into the groove 31), such that the tray 150, along with the stand 100, are securely locked or anchored into the upright position.

FIG. 2C shows the stand 100 securely anchored into the seat 10, as with FIG. 2B. The anchoring member 102 (not shown) is secured or locked in between the tray 150 and the receiving portion (not shown) of the seat 10. However, in FIG. 2C, the cantilevered member 106 is turned downward (e.g., at an angle of about 0 to 30 degrees relative to the anchoring member 102). A reading/electronic item 160 (e.g., a book) is placed onto the object support member 108 of the cantilevered member 106 and secured into place with the retainers/clips 110. The item 160 is placed at a level that is near the headrest 14 of the seat 10, and therefore higher than the level the item 160 would be if placed onto the tray top surface (e.g., tray top surface 152 in FIG. 5B) of a tray 150 that is released from the upright position and placed into a lowered position. As such, with the embodiment of FIG. 2C, the stand 100 places the item 160 closer to an eye-level of an average adult traveler, which can result in less eye and neck strain, and other forms of discomfort associated with the traveler reading from the item 160 placed onto the tray top surface or holding the item 160 with one's hands, particularly during extended trips.

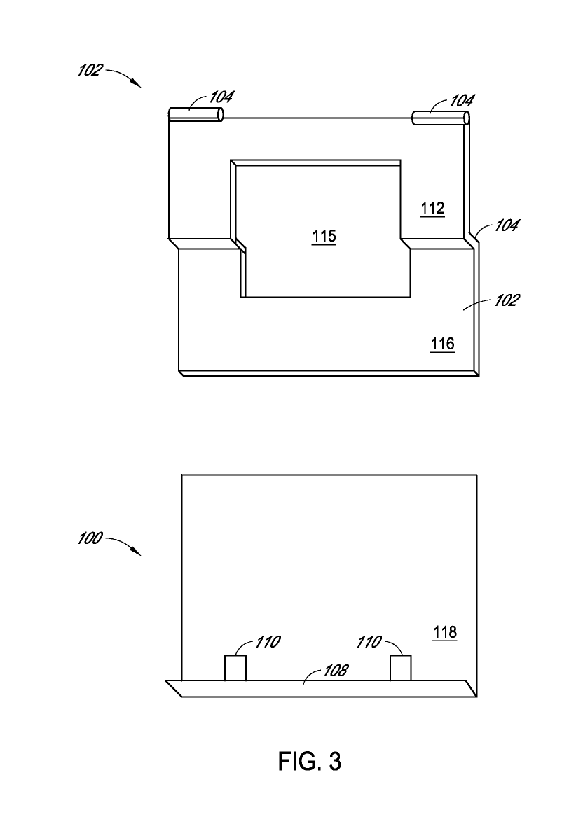

FIG. 3 shows the stand 100 with the anchoring and cantilevered members 102, 106 detached from each other. In the illustrated example, the hinges 104 are attached to the anchoring member 102. In another example, the hinges 104 are attached to the cantilevered member 106.

With reference once again to FIGS. 2A-B, the opening 115 within the anchoring member 102 exposes the tray lock in a seatback (e.g., the locking member 32, the groove/indentation 30, and the groove/indentation 31) for locking and unlocking the tray 150 (as well as the stand 100 into the tray 150). For example, the opening 115 is of a size to expose the locking member 32, the groove/indentation 30, and the groove/indentation 31 therethrough.

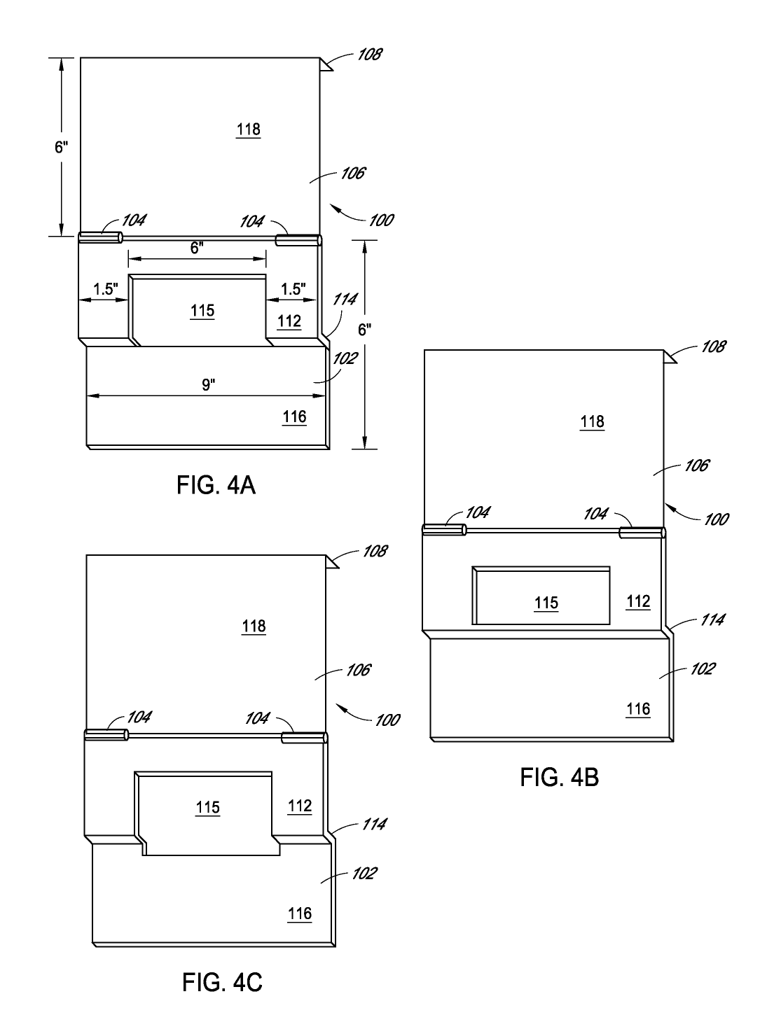

FIGS. 4A-C illustrate other embodiments of a stand that is similar to the stand 100 in FIGS. 1A-B. With reference to the example of FIG. 4A, the anchoring member 102′ of the stand 100′ is different from that of stand 100 in that the portions 112′, 114′, 116′ of the anchoring member 102′ form an external member that surrounds/defines an inner opening 115′ through top and middle portions 112′, 114′, but not through bottom portion 116′. Here, the opening 115′ is still of a size to expose the tray lock mechanism in a seatback (e.g., the locking member 32, the groove/indentation 30, and the groove/indentation 31 of FIGS. 2A-B).

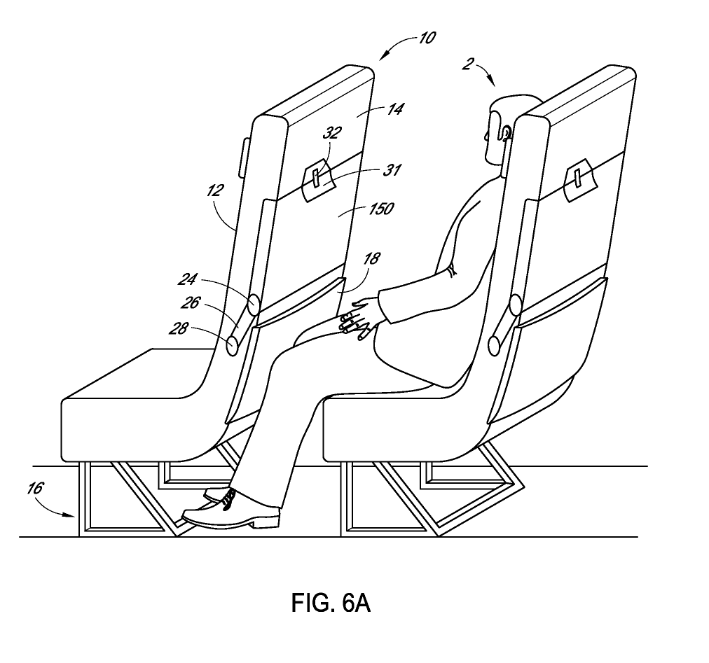

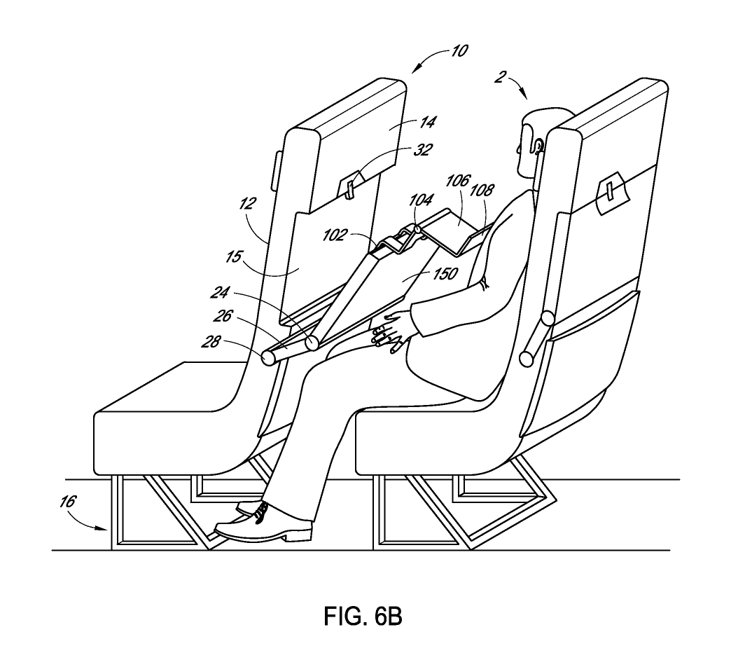

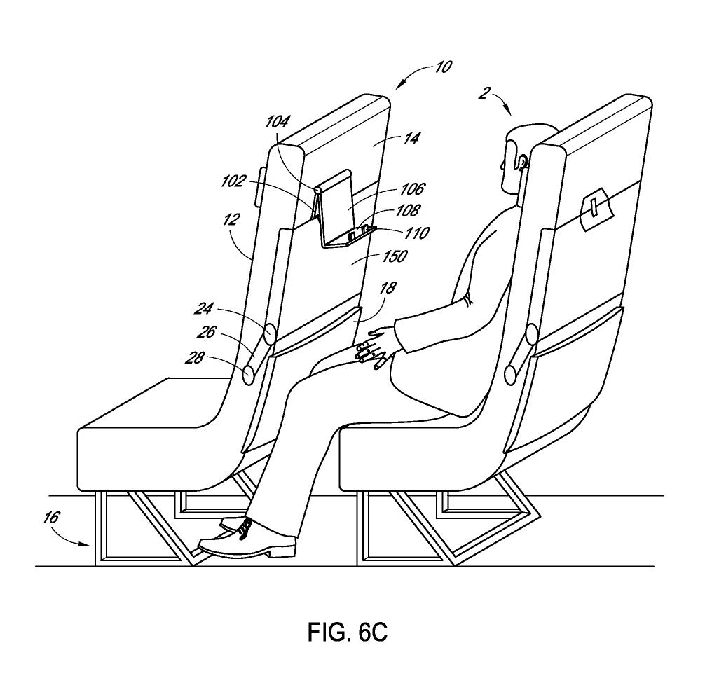

In related aspects, the opening 115′ through the middle portion 114′ may facilitate use of the stand 100′ with certain types of seatback trays, such as, for example, a tray (not shown) having a tray top edge (i.e., tray top edge 156 in FIGS. 5B and 6B below) that is rounded or not flat.

With reference to FIG. 4B, in another example, there is provided a stand 100″ having an anchoring member 102″ with portions 112″, 114″, 116″ that form an external member that surrounds/defines an inner opening 115″ that extends through the top portion 112″, but not through the middle or bottom portions 114″, 116″. Such a stand 100″ may be used, for example, with a seatback tray having a top edge that is flat or non-rounded.

With reference to FIG. 4C, in another example, the opening 115′″ may extend into a portion of the bottom portion 116′″ (i.e., not as deep into the bottom portion 116 as the opening 115 shown in FIG. 1A), resulting in an anchoring member 102′″ that is similar but not identical to the anchoring member 102 of FIG. 1A. As noted previously, one benefit of the opening 115′″, aside from exposing the tray lock in a seatback, is the provision of a stand 100′″ that is lightweight and easy for the traveler to carry or transport. FIGS. 5A-C illustrate a method of using a stand (e.g., the stand 100 in FIGS. 1A-B) in accordance with aspects of the present disclosure. FIG. 5A shows a traveler or passenger 2 seated in seat 10′ that is behind seat 10. The seat 10 includes a headrest 14, a seatback tray 150, and a seatback pocket 18. The seat 10 also includes a front portion 12 in which a passenger may be seated, and a base member 16 fixed to a floor of an airplane fuselage or a train compartment.

The tray 150 may be connected to the seat 10 via an attachment member 26 that includes a first hinge 24 that interfaces with the tray 150 and a second hinge 28 that interfaces with the seat 10. The first and second hinges 24, 28 allow the tray 150 to be moved between its upright position (e.g., locked into the seat 10) and released/lowered position. It is noted that the seat 10′ in which the traveler 2 is seated typically has the same or similar components/members and features as the seat 10 in front of the traveler 2.

FIG. 5B shows the tray 150 as unlocked and released from a receiving portion 15 of the seat 10. The tray 150 may have a tray top surface 152, a tray bottom surface 154, and a tray top edge 156. The stand 100 may be placed be secured within the seat 100 as follows. The bottom portion 116 of the anchoring member 102 of the stand 100 may be placed between the tray top surface 152 and the receiving portion 15 of the seat 10.

A bottom surface 103 (also shown in FIG. 1A) of the bottom portion 116 of the anchoring member 102 may be aligned with the tray top surface 152, such that the bottom surface 103 and the tray top surface 152 are substantially flush with each other (i.e., the bottom surface 103 is flush with at least a portion of the tray top surface 152). In certain scenarios, the bottom surface 103 and the tray top surface 152 simply abut each other along one or more points.

The middle portion 114 of the anchoring member 102 may be aligned with the tray top edge 156, such that the tray top edge 156 abuts or engages with at least a portion of the middle portion 114. In related aspects, with reference to example stand 100 of FIG. 1A, the opening 115 may extend into the middle portion 114, such that the middle portion 114 has a first section to the left of the opening 115 and a second section to the right of the opening 115. The tray top edge 156 may engage with the first and second sections of the middle portion 114. As such, the tray top edge 156 can simply be aligned with the first and second sections of the middle portion 114, rather than along the entirety of the middle portion 114. This is particularly beneficial when the tray top edge 156 is not completely straight and/or flat (e.g., the tray top edge 156 may be slightly contoured/curved and/or rounded).

With reference to FIG. 5C, the tray 150, along with the stand 100, may be moved into the upright position and into the receiving portion 15 of the seat 10. The anchoring member 102 may be secured or locked into the seat 10 by locking the tray 150 into the receiving portion 15 of the seat 10. For example, the locking member 32 (shown in FIGS. 2A-B and 5B) may be turned to a down/locked position into the groove 31 of the tray 150, as shown in FIG. 2B.

The cantilevered member 106 of the stand 100 may be rotated via at least one hinge 104 to adjust a position of the cantilevered member 106 relative to the secured anchoring member 102. An object (e.g., the reading/electronic item 160 of FIG. 2C) may be placed onto the object support member 108 of the stand 100. In related aspects, FIGS. 6A, 6B, and 6C provide perspective views of FIGS. 5A, 5B, and 5C, respectively.

In accordance with one or more aspects of the present disclosure, there is provided a method or procedure for using a stand in connection with a seatback tray of a passenger seat that is hingedly connected to the passenger seat and configured to be secured in an upright position by locking with a tray lock of the passenger seat. With reference to FIGS. 5A-C and 6A-C, the method may involve unlocking the tray lock and releasing the seatback tray 150 from its upright position. This step may involve rotating a locking member (e.g., the locking member 32 of FIGS. 2A-C) upward into the unlocked position to release the tray 150.

The method may then involve placing the bottom portion 116 of the anchoring member 102 between the tray top surface 152 and the seat 10 (e.g., the receiving portion 15 of the seat 10).

The method may then involve aligning the opening 115 of the anchoring member 102 with the tray lock (e.g., the locking member 32, the groove/indentation 30, and the groove/indentation 31 of FIGS. 2A-B) such that the tray lock is exposed through the opening 115. As shown in FIGS. 5B and 6B, this step may involve engaging or aligning the middle portion 114 of the anchoring member 102 with the tray top edge 156 of the tray 150. For example, if the anchoring member 102 has an opening 115 as shown in the embodiment of FIG. 1A (where the opening 115 extends into the middle portion 114, such that the middle portion 114 has a first section to the left of the opening 115 and a second section to the right of the opening 115), then this step may involve aligning and engaging the first and second sections of the middle portion 114 with corresponding left and right sections, respectively, on the top tray edge 156. In general at least one section of the middle portion 114 should engage with at least one section of the top tray edge 156, such that the tray lack is exposed and accessible through the opening 115.

The method may then involve locking the tray lock through the opening 115 to cause the tray 150 to stay in the upright position and further to secure the anchoring member 102 of the stand 10 between the tray 150 and the passenger seat 10.

The method may then involve rotating the cantilevered member 106 via the at least one hinge 104 to adjust a position of the cantilevered member 106 relative to the secured anchoring member 102.

The method may then involve placing an object on the object support member 108 of the stand 100 and adjusting at least one retainer/clip 110 to securely retain the object on the support member 108.

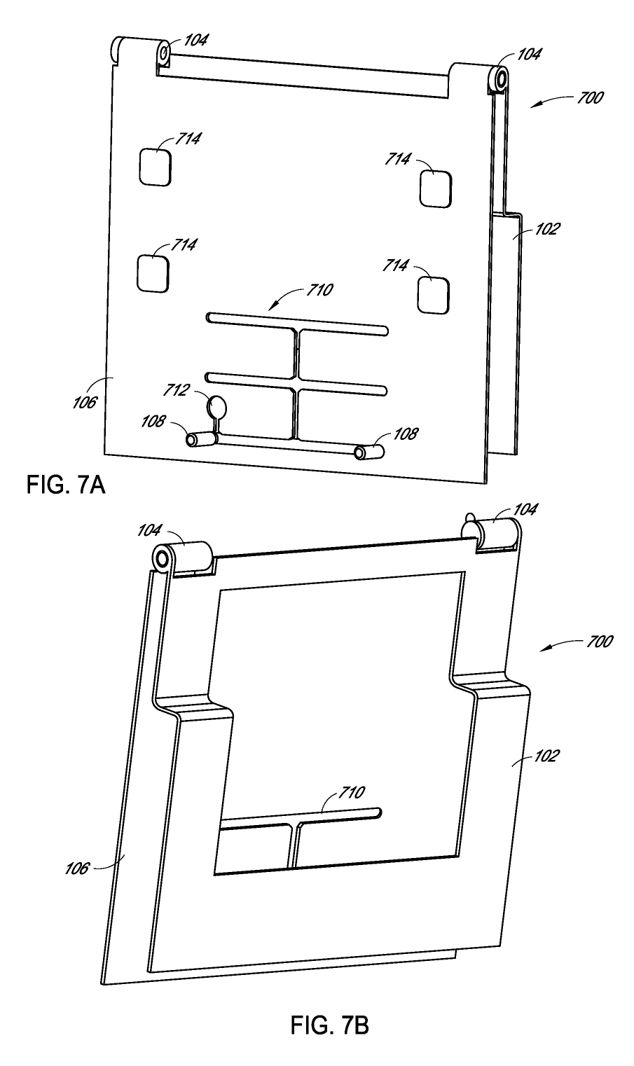

FIGS. 7A-B show another embodiment of a stand 700. The stand 700 may include an anchoring member 102 and a cantilevered member 106 that are connected and interface with each other via the hinges 104. The cantilevered member 106 may include a groove pattern 710 having one or more grooves within which the object support members 108 may be moved and secured in place (e.g., via friction, engaging grooves in the support members 108 that interface with the grooves of the pattern 710, or similar locking mechanism).

The groove pattern 710 may include a receiving slot 712 for receiving the object support members 108. The cantilevered member 106 may include object stabilizers 714 (e.g., rubber or plastic pads) to stabilize and further support an object placed onto the object support members 108.

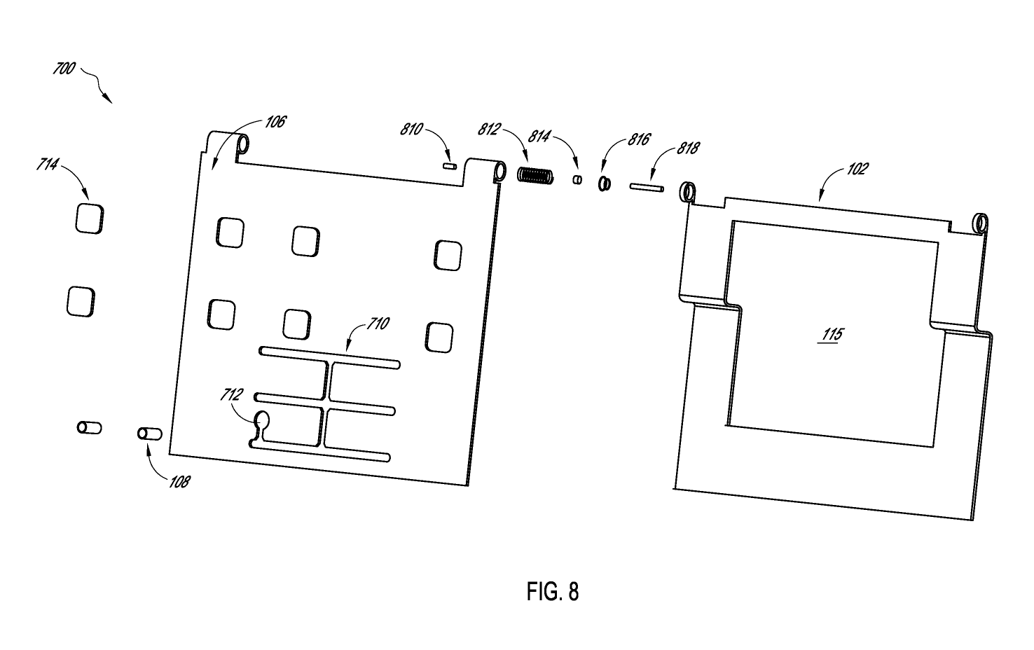

FIG. 8 provides an exploded view of the stand 700 of FIGS. 7A-B. FIG. 8 also shows the components of the hinges 104. For example, a given hinge 104 may include a pin 810, a spring or tensioner 812, a pin locking member 814, a fastener 816, and a pin 818.

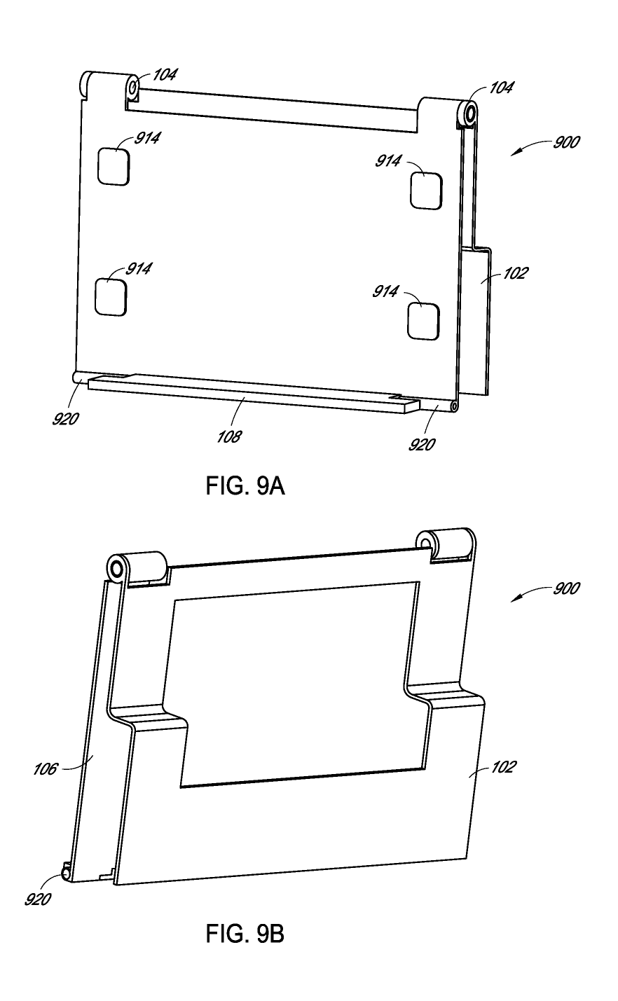

FIGS. 9A-B show another embodiment of a stand 900. The stand 900 may include an anchoring member 102 and a cantilevered member 106 that are connected and interface with each other via the hinges 104. The cantilevered member 106 may include object stabilizers 914 and an object support member 108 that is rotatable about one or more hinges 920.

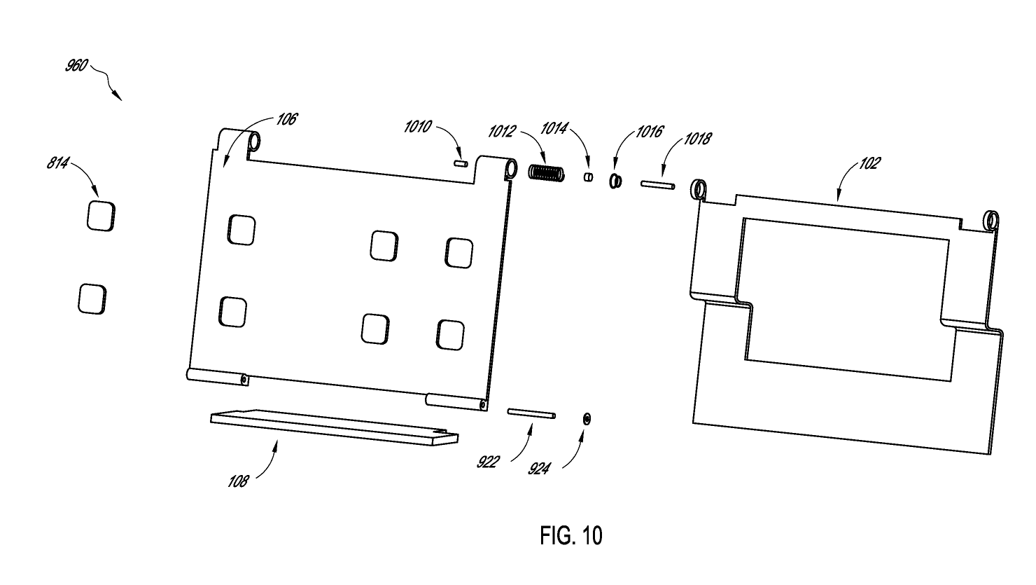

FIG. 10 provides an exploded view of the stand 900 of FIGS. 9A-B. FIG. 10 also shows the components of the hinges 104, 920. For example, a given hinge 104 may include a first pin 1010, a spring or tensioner 1012, a pin locking member 1014, a fastener 1016, and a second pin 1018. In another example, a given hinge 920 may include a pin 922 and a pin locking member 924.

FIG. 11 shows another embodiment of a stand 1100 that is similar to the example stands described above. For example, the proximal plane (in which the top portion 112 of the anchoring member 102 lies) and the transverse plane (in which the middle portion 114 of the anchoring member 102 lies) intersect to form an angle 1110 of about 85 to about 105 degrees relative to each other. The distal plane (in which the bottom portion 116 of the anchoring member 102 lies) and transverse plane (in which the middle portion 114 of the anchoring member 102 lies) may intersect to form an angle 1120 of about 80 to about 100 degrees relative to each other.

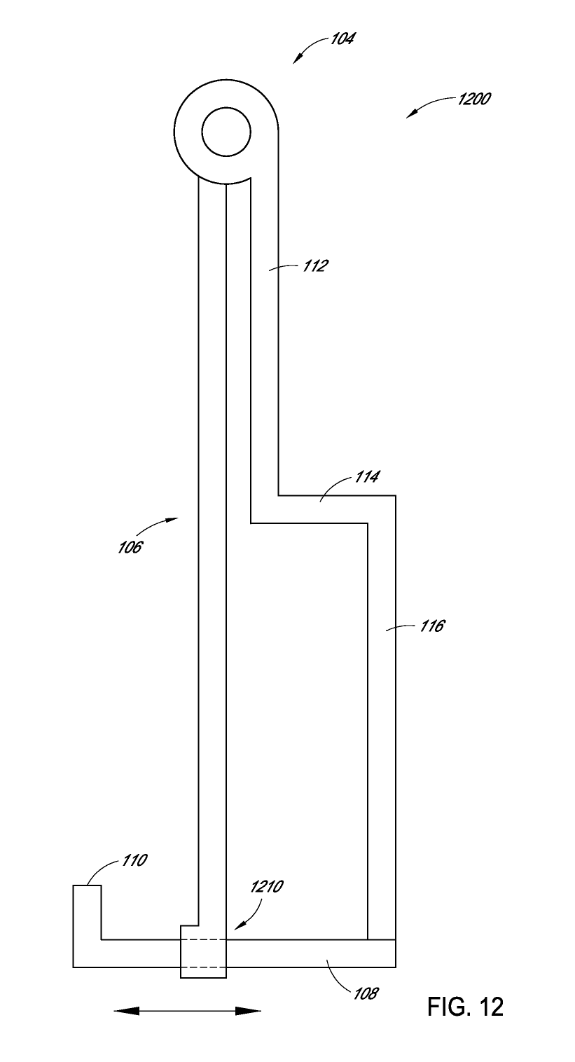

FIG. 12 shows yet another embodiment of a stand 1200. For example, the bottom portion 116 of the anchoring member 102 may include an object support member 108. The cantilevered member 106 may include a slot 1210 that receives the support member 108, such that the support member 108 may at least partially pass through the slot 1210. The traveler or user of the stand 1200 may place an object onto the support member 108 that passes through the slot 1210.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A stand for use in connection with a seatback tray of a passenger seat that is hingedly connected to the passenger seat and configured to be secured in an upright position by locking with a tray lock of the passenger seat, comprising:
an anchoring member comprising a top portion, a middle portion, and a bottom portion in a single piece body;
the top portion in a proximal plane, the top portion extending from a proximal top edge to a proximal bottom edge;
the bottom portion in a distal plane, the bottom portion extending from a distal top edge to a distal bottom edge;
the middle portion in a transverse plane intersecting the proximal and distal planes, the middle portion connected to the proximal bottom edge and the distal top edge, thereby connecting the top and bottom portions;
an opening formed in the single piece body of the anchoring member and sized to expose the tray lock for locking and unlocking therethrough;
at least one hinge at the proximal top edge of the anchoring member; and
a cantilevered member interfacing with and rotatable with respect to the anchoring member via the at least one hinge, the cantilevered member having an object support member.

2. The stand of claim 1, wherein the proximal and transverse planes intersect to form an angle that is less than 180 degrees relative to each other.

3. The stand of claim 1, wherein the angle is about 80 to about 100 degrees.

4. The stand of claim 1, wherein the distal and transverse planes intersect to form an angle that is less than 180 degrees relative to each other.

5. The stand of claim 1, wherein the angle is about 85 to about 95 degrees.

6. The stand of claim 1, wherein the opening is formed through the top portion of the single piece body of the anchoring member.

7. The stand of claim 1, wherein the opening is formed through the top portion and the middle portion of the single piece body of the anchoring member.

8. The stand of claim 1, wherein the opening is formed through the top portion, the middle portion and the bottom of the single piece body of the anchoring member.

9. The stand of claim 1, wherein:
the anchoring member comprises an anchoring panel; and
the cantilevered member comprises a cantilevered panel.

10. The stand of claim 1, wherein:
the object support member extends from the distal bottom edge of the bottom portion of the anchoring member; and
the cantilevered member comprises a slot that receives the object support member.

11. A method of using the stand of claim 1, the method comprising:
unlocking the tray lock and releasing the seatback tray from the upright position;
placing the bottom portion of the anchoring member between the tray top surface and the seat;
aligning the opening of the anchoring member with the tray lock such that the tray lock is exposed through the opening; and
locking the tray lock through the opening to cause the seatback tray to stay in the upright position and further to secure the anchoring member of the stand between the seatback tray and the passenger seat.

12. The method of claim 11, wherein placing the bottom portion and aligning the opening are performed concurrently.

13. The method of claim 11, further comprising rotating the cantilevered member via the at least one hinge to adjust a position of the cantilevered member relative to the secured anchoring member.

14. The method of claim 11, further comprising placing an object on the object support member of the stand.

15. The method of claim 11, wherein the opening is formed through the top portion of the single piece body of the anchoring member.

16. The method of claim 11, wherein the opening is formed through the top portion and the middle portion of the single piece body of the anchoring member.

17. The method of claim 11, wherein the opening is formed through the top portion, the middle portion and the bottom of the single piece body of the anchoring member.
